(19) United States
(12) Patent Application Publication
(10) Pub. No.: US 2023/0106632 A1
(43) Pub. Date: Apr. 6, 2023

(54) METHOD AND SYSTEM FOR INTELLIGENTLY GENERATING AND EDITING AUTOMATED TEST SCRIPTS FROM VIDEO

(71) Applicant: MICRO FOCUS LLC, SANTA CLARA, CA (US)

(72) Inventors: He-Jun Chen, Shanghai (CN); Jia Xue, Shanghai (CN)

(73) Assignee: MICRO FOCUS LLC, SANTA CLARA, CA (US)

(21) Appl. No.: 17/495,218

(22) Filed: Oct. 6, 2021

(51) Int. Cl. G06F 11/36; G06T 7/70; G06T 7/38; G06T 5/50

(52) U.S. Cl. CPC G06F 11/3684; G06F 11/3688; G06F 11/3664; G06T 7/70; G06T 7/38; G06T 5/50

(57) ABSTRACT

Methods and apparatus are disclosed to automatically generate a software test script from video and/or user input. Example methods disclosed herein include generating a first set of images from a video comprising recorded testing of software. The example method also includes processing the first set of images to remove unnecessary images. The example method also includes comparing each image to one or more adjacent images to identify one or more user actions performed in each image. The example method also includes translating each identified user action and/or user input into one or more test script parameters to generate an automated test script to execute on the software.

### FIELD

The disclosure relates generally to automatically generating and editing automated test scripts and particularly to systems and methods for automatically generating automated test scripts from a video using Artificial Intelligence.

### BACKGROUND

Software testing is performed to verify that software performs without error. The process of software testing includes performing various operations using the software in order to detect issues, debug the detected issues, and verifying the issue is resolved. Undesirable issues in software result in abnormal and/or unpredictable behavior of the software. For example, a shopping application exhibiting abnormal behavior may display incorrect items in a shopping cart when trying to make purchases via the shopping application. In another example, inventory may not be properly updated after a purchase is completed.

### SUMMARY

These and other needs are addressed by the various embodiments and configurations of the present disclosure. The present disclosure can provide a number of advantages depending on the particular configuration. These and other advantages will be apparent from the disclosure contained herein.

Software testing involves detecting issues in software that cause the software to behave abnormally. Based on the testing, the software can be debugged to eliminate the issues. Often, detecting issues in software and debugging the software is completed as two separate steps. Quality assurance engineers test software by executing the software (or application or program) and performing one or more user actions on the executing software. After a quality assurance engineer discovers or detects an issue, a software developer attempts to recreate the issue during a debugging process. A software developer is a person that writes software, debugs software, and corrects issues by re-writing software. In a manual debugging process, a software developer identifies user action(s) that led to the discovery of an issue, and repeats the user action(s) to recreate the issue. In an automated debugging process, a user simulation program executes a test script (which may have been manually created by a software developer) to simulate the user actions that previously led to discovery of an issue in an attempt to recreate the issue. In either case, skipping, missing or partially performing one or more operations or user actions may result in not being able to recreate the issue.

Some prior software testing techniques document sequences or orders of user input operations performed during a software testing process by recording (e.g., video recording) a display screen of software and/or recording a quality assurance engineer as the quality assurance engineer tests the software. A software developer is then able to watch the video and identify operations or user actions performed by the quality assurance engineer that led to abnormal software behavior. In some instances, the software developer may then write a test script for the steps to be executed on the software under test by a user simulation program to recreate any discovered issues. That is, a software developer watches the video and then writes down the user actions performed by the quality assurance engineer, and uses the written user actions to either perform manual debugging, or to manually generate a test script to reproduce the discovered issues.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine”, “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram illustrating elements of an example computing environment in which embodiments of the present disclosure may be implemented.

FIG. 2 is a block diagram illustrating elements of an example computing system in which embodiments of the present disclosure may be implemented.

FIG. 3 is a block diagram illustrating a software test environment according to one embodiment of the present disclosure.

FIGS. 4A-4C are diagrams illustrating an example of processing a first set of images to generate a second set of images according to one embodiment of the present disclosure.

FIG. 5 illustrates an example portion of a test script that may be generated by the systems of FIGS. 1-3 according to one embodiment of the present disclosure.

FIGS. 6A-6B are flowcharts illustrating an example process for the automatic generation of an automated test script according to one embodiment of the present disclosure.

FIG. 7 is a block diagram illustrating an example computing device for the automatic generation of an automated test script according to one embodiment of the present disclosure.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

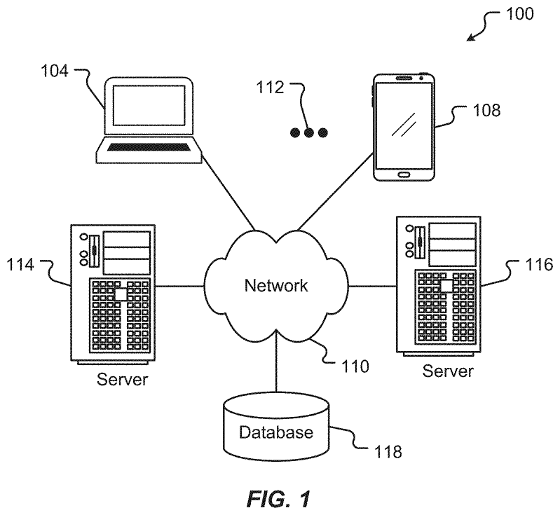

FIG. 1 is a block diagram illustrating elements of an example computing environment 100 in which embodiments of the present disclosure may be implemented. More specifically, this example illustrates a computing environment 100 that may function as the servers, user computers, or other systems provided and described herein. The environment 100 includes one or more user computers, or computing devices, such as a computer 104, a communication device 108, and/or more devices 112. The devices 104, 108, 112 may include general purpose personal computers (including, merely by way of example, personal computers, and/or laptop computers running various versions of Microsoft Corp.'s Windows® and/or Apple Corp.'s Macintosh® operating systems) and/or workstation computers running any of a variety of commercially-available UNIX® or UNIX-like operating systems. These devices 104, 108, 112 may also have any of a variety of applications, including for example, database client and/or server applications, and web browser applications. Alternatively, the devices 104, 108, 112 may be any other electronic device, such as a thin-client computer, Internet-enabled mobile telephone, and/or personal digital assistant, capable of communicating via a network 110 and/or playing audio, displaying images, etc. Although the example computer environment 100 is shown with two devices, any number of user computers or computing devices may be supported.

Environment 100 further includes a network 110. The network 110 may can be any type of network familiar to those skilled in the art that can support data communications using any of a variety of commercially-available protocols, including without limitation Session Initiation Protocol (SIP), Transmission Control Protocol/Internet Protocol (TCP/IP), Systems Network Architecture (SNA), Internetwork Packet Exchange (IPX), AppleTalk, and the like. Merely by way of example, the network 110 maybe a Local Area Network (LAN), such as an Ethernet network, a Token-Ring network and/or the like; a wide-area network; a virtual network, including without limitation a Virtual Private Network (VPN); the Internet; an intranet; an extranet; a Public Switched Telephone Network (PSTN); an infra-red network; a wireless network (e.g., a network operating under any of the IEEE 802.9 suite of protocols, the Bluetooth® protocol known in the art, and/or any other wireless protocol); and/or any combination of these and/or other networks.

The system may also include one or more servers 114, 116. For example, the servers 114 and 116 may comprise build servers, which may be used to test webpage layout on various screen sizes via the device 104, 108, 112. The servers 114 and 116 can be running an operating system including any of those discussed above, as well as any commercially available server operating systems. The servers 114 and 116 may also include one or more file and/or application servers, which can, in addition to an operating system, include one or more applications accessible by a client running on one or more of the devices 104, 108, 112. The server(s) 114 and/or 116 may be one or more general purpose computers capable of executing programs or scripts in response to the computers 104, 108, 112. As one example, the servers 114 and 116, may execute one or more automated tests. The automated tests may be implemented as one or more scripts or programs written in any programming language, such as Java^{TM}, C, C#®, or C++, and/or any scripting language, such as Perl, Python, or Tool Command Language (TCL), as well as combinations of any programming/scripting languages. The server(s) 114 and 116 may also include database servers, including without limitation those commercially available from Oracle®, Microsoft®, Sybase®, IBM® and the like, which can process requests from database clients running on the device 104, 108, 112.

The tests created and/or initiated by the device 104, 108, 112 (including tests created by other devices not illustrated) are shared to the server 114 and/or 116, which then may test and/or deploy the websites/webpages. The server 114 and/or 116 may transfer the generated webpage layout and/or data related to the same to the device 104, 108, 112. Although for ease of description, FIG. 1 illustrates two servers 114 and 116, those skilled in the art will recognize that the functions described with respect to servers 114, 116 may be performed by a single server and/or a plurality of specialized servers, depending on implementation-specific needs and parameters. The computer systems 104, 108, 112, and servers 114 116 may function as the system, devices, or components described herein.

The environment 100 may also include a database 118. The database 118 may reside in a variety of locations. By way of example, database 118 may reside on a storage medium local to (and/or resident in) one or more of the computers/servers 104, 108, 112, 114, 116. Alternatively, it may be remote from any or all of the computers/servers 104, 108, 112, 114, 116, and in communication (e.g., via the network 110) with one or more of these. The database 118 may reside in a Storage-Area Network (SAN) familiar to those skilled in the art. Similarly, any necessary files for performing the functions attributed to the computers/servers 104, 108, 112, 114, 116 may be stored locally on the respective computer/server and/or remotely, as appropriate. The database 118 may be used to store webpage layout data (e.g., respective locations of a plurality of elements), alerts, etc.

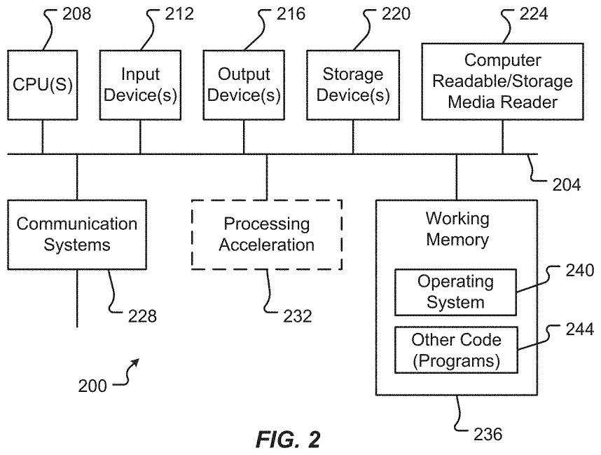

FIG. 2 is a block diagram illustrating elements of an example computing system 200 in which embodiments of the present disclosure may be implemented. More specifically, this example illustrates one embodiment of a computer system 200 upon which the servers, computing devices, or other systems or components described above may be deployed or executed. The computer system 200 is shown comprising hardware elements that may be electrically coupled via a bus 204. The hardware elements may include one or more Central Processing Units (CPUs) 208; one or more input devices 212 (e.g., a mouse, a keyboard, etc.); and one or more output devices 216 (e.g., a display device, a printer, etc.). The computer system 200 may also include one or more storage devices 220. By way of example, storage device(s) 220 may be disk drives, optical storage devices, solid-state storage devices such as a Random-Access Memory (RAM) and/or a Read-Only Memory (ROM), which can be programmable, flash-updateable and/or the like.

The computer system 200 may additionally include a computer-readable storage media reader 224; a communications system 228 (e.g., a modem, a network card (wireless or wired), an infra-red communication device, etc.); and working memory 236, which may include RAM and ROM devices as described above. The computer system 200 may also include a processing acceleration unit 232, which can include a Digital Signal Processor (DSP), a special-purpose processor, and/or the like.

The computer-readable storage media reader 224 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 228 may permit data to be exchanged with a network and/or any other computer described above with respect to the computer environments described herein. Moreover, as disclosed herein, the term “storage medium” may represent one or more devices for storing data, including ROM, RAM, magnetic RAM, core memory, magnetic disk storage mediums, optical storage mediums, flash memory devices and/or other machine-readable mediums for storing information.

The computer system 200 may also comprise software elements, shown as being currently located within a working memory 236, including an operating system 240 and/or other code 244. It should be appreciated that alternate embodiments of a computer system 200 may have numerous variations from that described above. For example, customized hardware might also be used and/or particular elements might be implemented in hardware, software (including portable software, such as applets), or both. Further, connection to other computers such as network input/output devices may be employed.

Examples of the processors 208 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

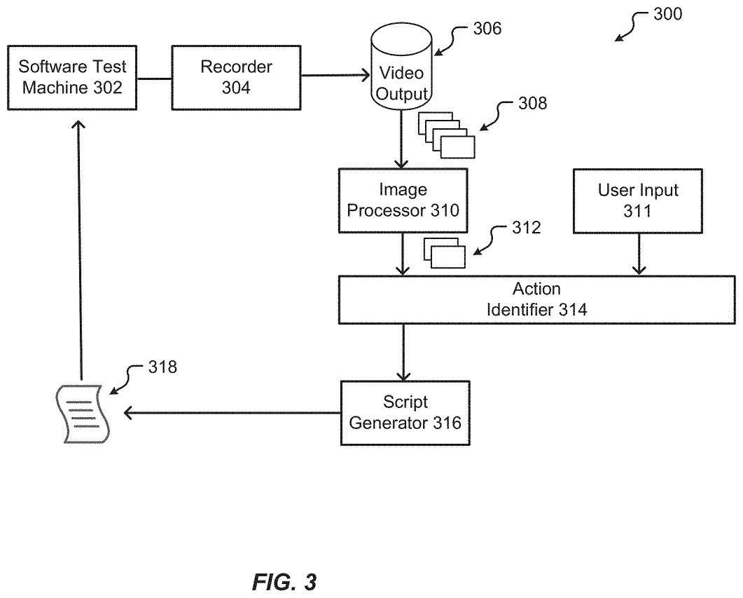

FIG. 3 is a block diagram of a software testing environment 300 that converts video and/or image data into an automated test script 316. Video data (e.g., a video and/or images) may be converted to an automation script. Additionally, a user may edit test script in real-time while playing/watching the video. In some embodiments, stable images are generated/captured from the video using an Artificial Intelligence (AI) tool, which can remove duplicate stable images and identify user actions in the stable images. An automation script is generated based on the identified user actions. During the process of generating the test script, the user can add personalized steps by pausing video. In some examples, if a user action cannot be clearly identified from a stable image, the user may also be queried regarding the appropriate user action. In some embodiments, the system will provide the user with several possible user actions identified in the stable image. Additionally, or alternatively, the user may customize the test script by adding additional user actions/test steps manually.

The software testing environment 300 includes a software test machine 302 that may run the software being testing and also run a generated automated test script 316. The software testing environment also includes a recorder 304, a storage 306 (e.g., a database) for storing the video output from the recorder 304, an image processor 310, an action identifier 314, and a script generator 316 that generates the automated test script 318.

The image processor 310 may receive video data recorded by the recorder 304. The image processor 310 generates a first set of images from the video data. For example, the image processor 310 may capture one or more stable images (e.g., the first set of images 308) from the video output from the recorder 304 using an AI tool (e.g., UFT Codeless). In some cases, a stable image may span more than one frame resulting in redundant images that may be deleted to generate a set of images with only the relevant images (e.g., the second set of images 312).

The action identifier 314 identifies user action/test steps in each of the remaining stable images. In some embodiments, the action identifier 314 analyzes two adjacent stable images to identify the user action performed. For example, the first stable image contains an empty editbox, and in the following stable image the value “ABC” is in the editbox.

Therefore, connection is that a user input the text “ABC” in the editbox. Continuing the example, the script generator 310 will a step called “Editbox.edit (ABC)” as a test step. Additionally, test steps in the generated test script 318 may include time range information (e.g., timestamp data for the associated video). In additional to video data, the action identifier 314 may receive user input data 311. For example, if a user action cannot be clearly identified from a stable image, the user may also be queried regarding the appropriate user action. The system may provide the user with several possible user actions identified based on the stable image. Additionally, or alternatively, the user may customize/edit the test script by adding additional user actions/test steps manually via the user input 311. The script generator 316 generates the test script 318 that may then be run on the software test machine 302.

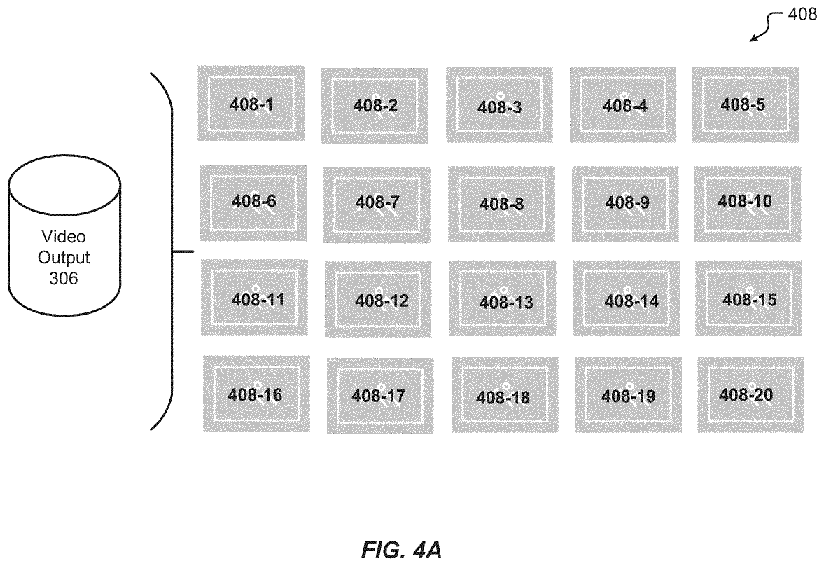

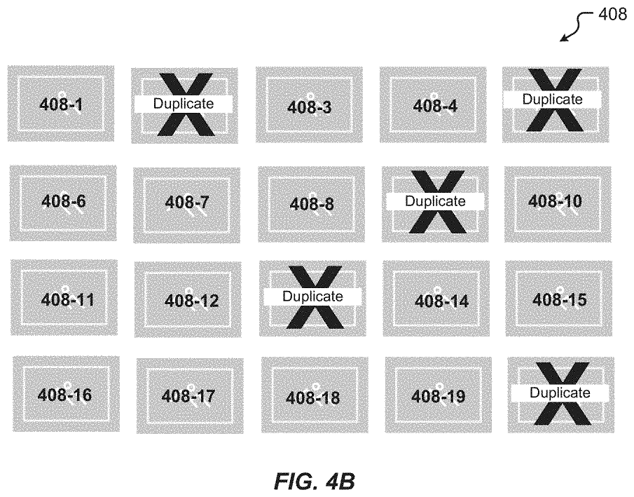

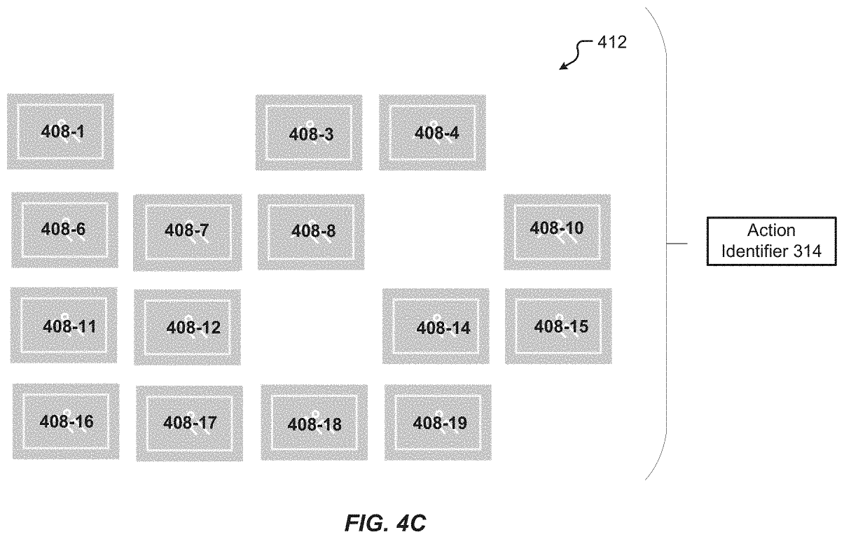

FIGS. 4A-4C illustrate the process of generating the stable images 408 from the video 306.

Referring to FIG. 4A, the video output 306 is processed to generate a set of stable images 408. For example, the video output 306 may comprise a recording of a test of a software program, webpage, etc. The set of stable images 408 comprises twenty images 408-1-408-20. It is understood that the set of stable images 408 is for illustration purposes only and fewer or more stable images 408 may be captured.

In FIG. 4B, unnecessary (e.g., redundant, duplicate, etc.) images are deleted from the set of stable images 408 (e.g., the first set of images 308). FIG. 4C illustrates a set of stable images 412 with the unnecessary images from the set of images 408 removed. For example, a user action may span several images (e.g., frames) and therefore there is no change from one image to the next adjacent image. In another example, an image may not contain a user action/test step and is therefore unnecessary. In FIG. 4C, the set of images 412 is transferred to the action identifier 314 for processing.

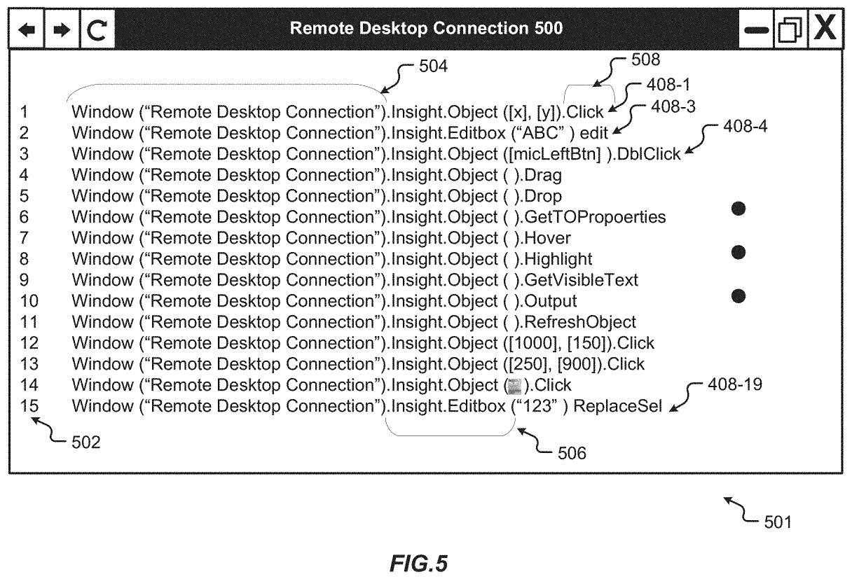

FIG. 5 illustrates an example portion of a test script (e.g., the test script 318) that may be generated by the example script generator 316 of FIG. 3 and executed by the example software test machine 302 of FIG. 3.

In the illustrated example 501, the test scripts include example instruction window descriptors 504, example instruction object descriptors 506 and example instruction event descriptors 508. In the illustrated example 501, the instruction window descriptor 504 specifies which window or panel of a display on which the user program should focus when executing a user action. For example, when the user program executes a script, the user program focuses on an application in which the window title is “Remote Desktop Connection,” which may correspond to, for example, the Microsoft remote desktop connection application.

In the illustrated example, the user simulation program executes the instruction event descriptor 508 based on the instruction object descriptor 506. For example, when executing the script, the user simulation program scans the window corresponding to the “Remote Desktop Connection” user interface for an image object and then “clicks” on the image object in the “Remote Desktop Connection” user interface of the software under test. In the illustrated example, the image object included in the script is located at ([x], [y]). In the illustrated example 501, when executing the script, the user simulation program scans the “Remote Desktop Connection” window and inputs the text string “ABC” in a textbox. Using similar processes, the example user simulation program executes each step of the example script 501 to recreate a software test run that was recorded by the recorder 304. As illustrated each step of the test example 501 corresponds with an image (408) from the set of images 412 illustrated in FIG. 4C.

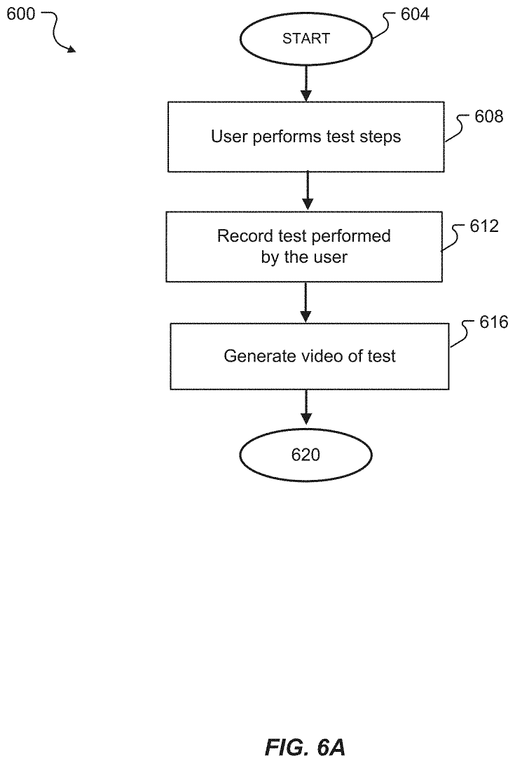

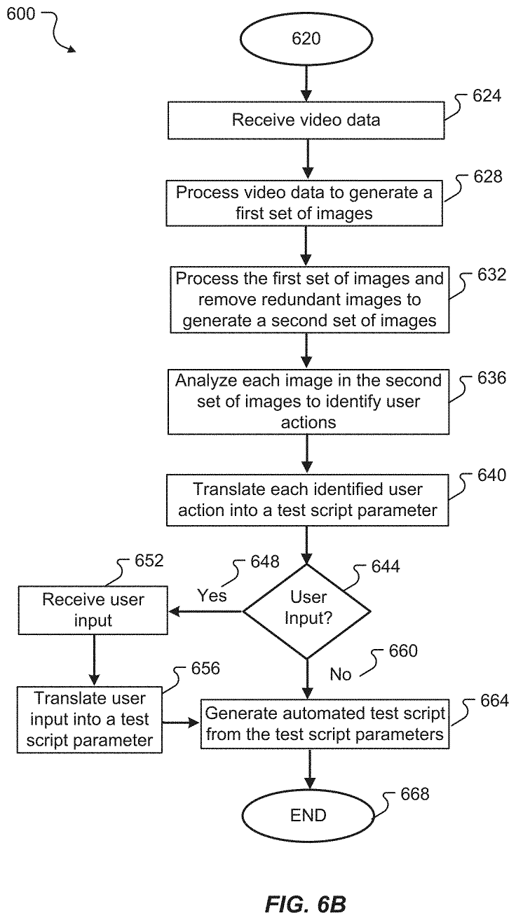

FIGS. 6A-6B are flow diagrams of a process 600 for automatically generating automated test scripts from a video using Artificial Intelligence. As one of skill in the art would recognize, there may be various ways to implement a process to generate automated test scripts from a video using Artificial Intelligence.

While a general order for the steps of the process 600 for the operation of automatically generating automated test scripts from a video using Artificial Intelligence is shown in FIG. 6, the process 600 can include more or fewer steps or can arrange the order of the steps differently than those shown in FIG. 6. Further, two or more steps may be combined into one step. Generally, the process 600 starts with a START operation 604 and ends with an END operation 668.

In step 608 a user runs a test on software, a website, etc. For example, a user may test a supported screen size for a webpage. In step 612 the test steps performed by the user while running the test is recorded as a video (e.g., the video output 306 recorded by the recorder 304). In step 616 the video is generated from the video output 306.

FIG. 6B illustrates a second part of the process 600 to automatically generate an automated test script from a video and user input. The process 600 continues from step 620 in FIG. 6A. In step 624 the video captured is received. For example, the video output 306 is transferred from the storage 306 to the image processor 310. In step 626 a set of images (e.g., 308 and 408) is generated from the received video. In stop 632 the set of images is processed to remove unnecessary images. For example, some images may be duplicate/redundant. In other examples, an image may not contain a user action. The unnecessary images are removed/deleted to generate a second set of image (e.g., 312 and 412). In step 636 each image in the second set of images is analyzed to identify a user action. For example, adjacent images may be compared to detect/identify the user action (e.g., operation performed). For example, a user may click a button, may enter text into a textbox, may drag and drop an object, etc. In step 640 each identified user action is translated into a test script parameter. In step 644 if user input is detected (Yes step 648), the user input is received in step 652. For example, a user may pause the video to manually enter a test step/operation. In another example, the system may be unable to accurately identify the appropriate user action, and queries the user (e.g., provides various options for user selection). In step 656 the received user input is translated into test scripts parameters. The process 600 proceeds to step 664 in which the test script (e.g., the test script 318) is generated based on the one or more test script parameters derived from the images and/or user input. If no user input is received (No step 660) the process 600 proceeds to step 664. The process 600 ends in step 668.

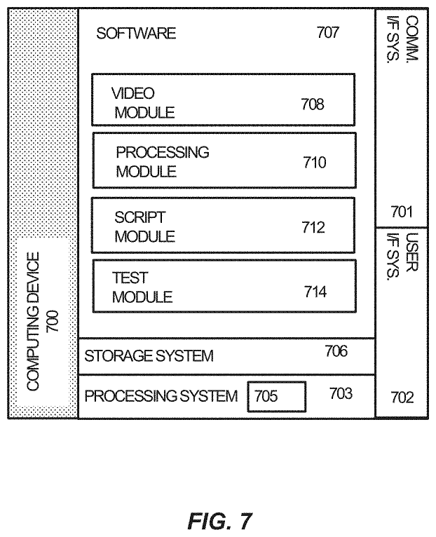

FIG. 7 depicts a computing device 700 in accordance with embodiments of the present disclosure. The computing device 700 performs the automatic generation of automated test scripts from a video using Artificial Intelligence in accordance with the embodiments disclosed herein.

The computing device 700 receives video data. For example, the computing device 700 may retrieve a video of a test performed on software recorded by a recorder. In some embodiments, the computing device 700 may store the video data in the storage system 706 and display/play the video data via the user interface system 702 (e.g., display and/or a speaker or headphones connected to computing device 700). Similar computing systems may be included in devices 104, 108, and 112, in whole or in part, described herein to perform the automatic generation of an automated test script from video data and user input.

A computing system 700 is representative of any computing system or systems with which the various operational architectures, processes, scenarios, and sequences disclosed herein to perform the automatic generation of an automated test script comprising various components and connections to other components and/or systems.

The computing system 700 comprises a communication interface 701, a user interface system 702, and a processing system 703. The processing system 703 is linked to the communication interface 701 and user interface system 702. The processing system 703 includes a microprocessor and/or processing circuitry 705 and a storage system 706 that stores operating software 707. The computing system 700 may include other well-known components such as a battery and enclosure that are not shown for clarity. The computing system 700 may comprise a server, a user device, a desktop computer, a laptop computer, a tablet computing device, or some other user communication apparatus.

The communication interface 701 comprises components that communicate over communication links, such as network cards, ports, radio frequency (RF), processing circuitry and software, or some other communication devices. Communication interface 701 may be configured to communicate over metallic, wireless, or optical links. Communication interface 701 may be configured to use Time Division Multiplex (TDM), Internet Protocol (IP), Ethernet, optical networking, wireless protocols, communication signaling, or some other communication format—including combinations thereof. In some implementations, the communication interface 701 is configured to communicate with other devices, wherein the communication interface 701 is used to retrieve a video for generating an automated test script.

The user interface system 702 comprises components that interact with a user to display the video and/or images, query for user input. For example, the user interface system 702 may been split in to two separate parts. A first part for displaying the test script and a second part to display the video. A user may play and pause the video. Generation of the test script will be stopped while the video is paused. The user interface system 702 may include a speaker, microphone, buttons, lights, display screen, touch screen, touch pad, scroll wheel, communication port, or some other user input/output apparatus—including combinations thereof.

The processing circuitry 705 may be embodied as a single electronic microprocessor or multiprocessor device (e.g., multicore) having therein components such as control unit(s), input/output unit(s), arithmetic logic unit(s), register(s), primary memory, and/or other components that access information (e.g., data, instructions, etc.), such as received via a bus, executes instructions, and outputs data, again such as via the bus. In other embodiments, the processing circuitry 705 may comprise a shared processing device that may be utilized by other processes and/or process owners, such as in a processing array or distributed processing system (e.g., “cloud,” farm, etc.). It should be appreciated that the processing circuitry 705 is a non-transitory computing device (e.g., electronic machine comprising circuitry and connections to communicate with other components and devices). The processing circuitry 705 may operate a virtual processor, such as to process machine instructions not native to the processor (e.g., translate the Intel® 9xx chipset code to emulate a different processor's chipset or a non-native operating system, such as a VAX operating system on a Mac), however, such virtual processors are applications executed by the underlying processor and the hardware and other circuitry thereof.

The processing circuitry 705 comprises a microprocessor and other circuitry that retrieves and executes the operating software 707 from the storage system 706. The storage system 706 may include volatile and nonvolatile, removable, and non-removable media implemented in any method or technology for storage of information, such as computer readable instructions, data structures, program modules, or other data. The storage system 706 may be implemented as a single storage device, but may also be implemented across multiple storage devices or sub-systems. The storage system 706 may comprise additional elements, such as a controller to read the operating software 707. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. It should be understood that in no case is the storage media a propagated signal.

The processing circuitry 705 is typically mounted on a circuit board that may also hold the storage system 706 and portions of the communication interface 701 and the user interface 702. The operating software 707 comprises computer programs, firmware, or some other form of machine-readable program instructions. The operating software 707 includes video module 708, image processing module 710, script module 712, and test module 714, although any number of software modules within the application may provide the same operation. The operating software 707 may further include an operating system, utilities, drivers, network interfaces, applications, or some other type of software. When executed by the processing circuitry 705, the operating software 707 directs the processing system 703 to operate the computing device 700 as described herein.

In at least one implementation, the video module 608, when read and executed by the processing system 703, directs the processing system 703 to record a video of a test running (e.g., the recorder 304). The processing module 710 when read and executed by the processing system 703, directs the processing system 703 to generate images (e.g., still images) from the video. The processing module 710 when read and executed by the processing system 703, further directs the processing system 703 to process the images to remove redundant/duplicate images and/or images in which no user action is identified (e.g., the image processor 310). Script module 712 when read and executed by the processing system 703, directs the processing system 703 to analyze the generated images to identify user actions and generate a test script (e.g., the test script 318) based on the identified user actions (e.g., the action identifier 314 and the script generator 316). The script module 712 may also receive user input (e.g., the user input 311) in order to generate the test script.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-MM processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments , configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method of generating an automated test script, comprising:
generating a first set of images from a video;
processing the first set of images to remove unnecessary images to generate a second set of images;
analyzing each image in the second set of images by comparing each image to one or more adjacent images to identify one or more user actions performed in each image; and
translating each identified user action into one or more test script parameters to generate the automated test script.

2. The method of claim 1, further comprising:
while processing a particular image in the second set of images, receiving input from a user to manually enter an additional test script parameter in the automated test script;
analyzing the particular image to determine at least one suggested test script parameter to provide to the user;
receiving a selection of one of the at least one suggested test script parameter; and
adding the selected one of the at least one suggested test script parameter to the automated test script.

3. The method of claim 2, wherein processing the particular image to determine the at least one suggested test script parameter comprises identifying each element in the particular image, and wherein determining the at least one suggested test script parameter to provide to the user comprises determining the at least one suggested test script parameter based on each element identified in the particular image.

4. The method of claim 1, wherein the one or more adjacent images comprises at least one of a prior image and/or a subsequent image.

5. The method of claim 1, wherein each test script parameter includes time range information identifying one or more images in the second set of images associated with a respective test script parameter.

6. The method of claim 1, wherein processing the first set of images to remove the unnecessary images to generate the second set of images comprises processing the first set of images using an Artificial Intelligence Algorithm.

7. The method of claim 1, wherein processing each image in the second set of images by comparing each image to the one or more adjacent images to determine the one or more user actions performed comprises processing the second set of images using an Artificial Intelligence Algorithm.

8. An apparatus to generate an automated test script, comprising:
a processor; and
a memory storing instructions that, when executed by the processor, cause the processor to:
generate a first set of images from a video;
process the first set of images to remove unnecessary images to generate a second set of images;
analyze each image in the second set of images by comparing each image to one or more adjacent images to determine one or more user actions performed; and
translate each identified user action into a test script parameter to generate the automated test script.

9. The apparatus of claim 8, wherein the instructions further cause the processor to:
while processing a particular image in the second set of images, receive input from a user to manually enter an additional test script parameter for the automated test script;
analyze the particular image to determine at least one suggested test script parameter to provide to the user;
receive a selection of one of the at least one suggested test script parameter; and
add the selected one of the at least one suggested test script parameter to the automated test script.

10. The apparatus of claim 9, wherein the instructions further cause the processor to:
identify each element in the particular image; and
determine the at least one suggested test script parameter based on each element identified in the particular image.

11. The apparatus of claim 8, wherein the one or more adjacent images comprises at least one of a prior image and/or a subsequent image.

12. The apparatus of claim 8, wherein each test script parameter includes time range information identifying one or more images in the second set of images associated with a respective test script parameter.

13. The apparatus of claim 8, wherein the instructions further cause the processor to:
process the first set of images using an Artificial Intelligence Algorithm.

14. The apparatus of claim 8, wherein the instructions further cause the processor to:
process the second set of images using an Artificial Intelligence Algorithm.

15. A tangible non-transitory computer readable storage medium comprising instructions that when executed cause a machine to:
generate a first set of images from a video;
process the first set of images to remove unnecessary images to generate a second set of images;
analyze each image in the second set of images by comparing each image to one or more adjacent images to determine one or more user action performed; and
translate each identified user action into a test script parameter to generate an automated test script.

16. The tangible non-transitory computer readable storage medium of claim 15, wherein the instructions further cause the machine to:
while processing a particular image in the second set of images, receive input from a user to manually enter an additional test script parameter for the automated test script;
analyze the particular image to determine at least one suggested test script parameter to provide to the user;
receive a selection of one of the at least one suggested test script parameter; and
add the selected one of the at least one suggested test script parameter to the automated test script.

17. The tangible non-transitory computer readable storage medium of claim 16, wherein the instructions further cause the machine to:
identify each element in the particular image; and
determine the at least one suggested test script parameter based on each element identified in the particular image.

18. The tangible non-transitory computer readable storage medium of claim 16, wherein the one or more adjacent images comprises at least one of a prior image and/or a subsequent image.

19. The tangible non-transitory computer readable storage medium of claim 16, wherein each test script parameter includes time range information identifying one or more images in the second set of images associated with a respective test script parameter.

20. The tangible non-transitory computer readable storage medium of claim 16, wherein the instructions further cause the machine to:
process the first set of images using an Artificial Intelligence Algorithm.
